(19) United States
(12) Patent Application Publication
(10) Pub. No.: US 2007/0240401 A1
(43) Pub. Date: Oct. 18, 2007

(54) GENERATION OF ELECTRICITY FROM HEAT OF COMBUSTION ENGINE

(76) Inventor: Mark McNeely, Mercer Island, WA (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/672,464

(22) Filed: Feb. 7, 2007

Related U.S. Application Data
(60) Provisional application No. 60/771,074, filed on Feb. 7, 2006.

(51) Int. Cl. F02C 6/00

(52) U.S. Cl. 60/39.182

(57) ABSTRACT

The invention contemplates a system having an engine linked to the turbine blade of a turbocharger to generate electricity. The turbine blade is associated with a housing of the turbocharger, which housing is in fluid communication with an exhaust stream of the engine. The turbine blade is configured to be driven by the exhaust stream. A generator may be associated with the turbine blade via a shaft, wherein when the turbine blade is driven by the exhaust stream, the generator generates electricity.

### CROSS-REFERENCE TO RELATED APPLICATIONS

This application claims benefits from U.S. Provisional Patent Application, Ser. No. 60/771,074 filed on Feb. 7, 2006, entitled “COMBUSTION ENGINE ELECTRICITY GENERATION FROM HEAT,” the contents of which are hereby incorporated by reference in their entirety.

### BACKGROUND OF THE INVENTION

1. The Field of the Invention

The internal combustion engine was invented by Nicholas Otto in 1861. For a 143 year old invention it has proven remarkably resilient. But its principal flaw—it's thermal and thus energy inefficiency—has become a serious concern in modern times.

The efficiencies of modern Otto-cycle engines range between 20%-25%. In other words, a relatively small percentage of the energy of the fuel is transformed into motion. Thus, a large percentage of each gallon of gas is not converted to motion but rather dissipated, largely in the form of “waste heat.” Cooing systems, radiators and exhaust system are utilized for the purpose of dissipating this heat.

### DETAILED DESCRIPTION OF THE PREFERRED EMBODIMENTS

There are many efforts underway to recapture the energy wasted by internal combustion powered vehicles. Garnering attention are hybrid vehicles, which are powered both by gas and electric engines. Hybrid vehicles can allow the combustion engine to run in its most efficient range and recapture the energy that would normally be wasted in braking. Furthermore, hybrid vehicles can be configured to convert the kinetic energy of motion to electricity. This electricity and recaptured energy can be stored in the vehicles onboard batteries.

The hybrid vehicle enables the adoption of the invention in existing vehicles. The electricity management and storage capabilities that the invention may utilize may become widely implemented. The invention relates to harnessing heat generated by the process of internal combustion and converting it to electricity. This can provide for more efficient use of the available energy in fuel.

The invention is directed to capturing waste heat at or close to the source and converting it to electricity. This electricity may enter and be stored in the battery storage system of hybrid (or even non-hybrid) cars. There exists a tremendous and untapped energy source in combustion engines, as the temperature of exhaust gasses may range from 1300° C. to 1500° C. and the header temperature may range from 800° C. to 900° C.

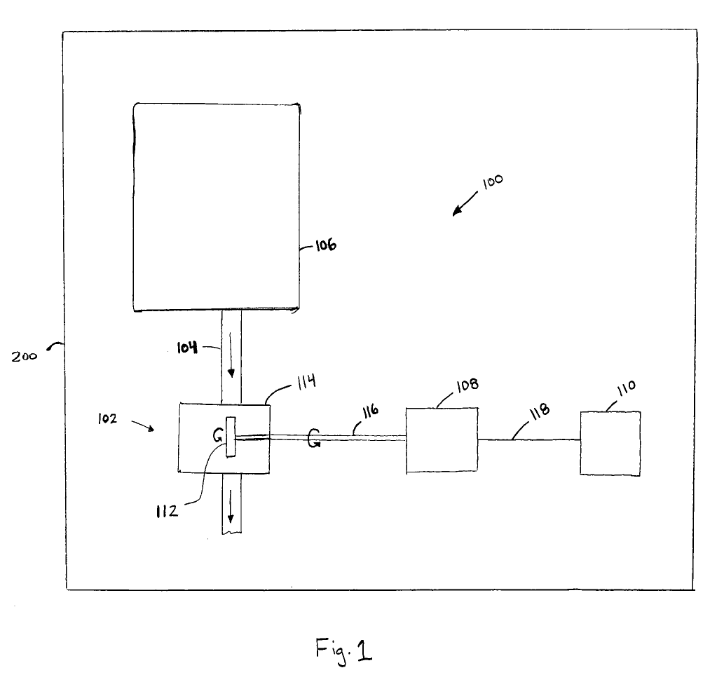

With reference to FIG. 1, the invention may be implemented utilizing a turbocharger, which can capture and harness waste heat and pressure from the exhaust stream to increase the horsepower of an engine. In general, a turbocharger utilizes energy from the exhaust stream to compress air directed into the engine cylinder, which in turn enables the generation of higher horsepower. In use, a turbocharger is in fluid communication with the exhaust of a combustion engine. The turbocharger may include a turbine blade which is driven or spun by the exhaust from the engine cylinder. In typical embodiments, the turbine blade is coupled or linked to a compressor via a shaft. As the exhaust drives the turbine blade, the turbine blade in turn drives a compressor wheel in the compressor. In this manner, the compressor pressurizes the air going into the pistons.

The invention contemplates utilizing the energy of the exhaust to drive a turbine blade to generate electricity, rather than using that energy to pressurize the air intake stream. In one embodiment of the invention, the driving of the turbine blade drives a generator to add electricity to the storage reservoir now in hybrid cards. For example, the turbine blade may be linked to a generator via a shaft. As the turbine blade is driven or rotates, the motion of the turbine blade is transmitted along the shaft to the generator. The generator is configured to produce electricity from the rotation of the shaft. In this manner, energy from the exhaust may be utilized to generate electricity. This invention reprioritizes the motives of the engine system. Heat is now treated as an asset to be converted to energy, rather than a waste byproduct.

FIG. 1 illustrates a system 100 in which the invention is utilized. In the illustrated embodiment, the system 100 includes a turbocharger 102 in fluid communication with an exhaust stream 104 from an engine 106, the turbocharger 102 being linked to a generator 108 to generate electricity which can be stored in a storage unit 110, such as one or more batteries. It is contemplated that the turbocharger 102 can include a turbine blade 112 enclosed in a housing 114, such as with a conventional turbocharger. The turbine blade 112 can be linked to the generator 108 via a shaft 116, such that rotation of the turbine blade 112 corresponds with rotation of the shaft 116.

Generator 108 is configured to generate electricity from rotation of the shaft 116. In conventional turbochargers, as described above, rotation of the shaft connected to the turbine blade is transferred to a compressor to compress air in a cylinder. In the system 100, rather than the shaft of a turbocharger system being coupled to a compressor, the shaft 116 is linked to a generator 108 to produce electricity.

The exhaust stream 104 flows from the engine 106 into housing 114, as indicated. Housing 114 can be configured to route exhaust such that it is forced to flow past the turbine blade 112, thus causing the turbine blade 112 to rotate. Rotation of turbine blade 112 causes shaft 116 to rotate, as indicated by the curved arrows. As shaft 116 rotates, generator 108 can generate electricity. Generator 108 can be in electronic communication with storage unit 110 by a wire 118, such that as generator 108 generates electricity from the rotation of turbine blade 112, the generated electricity flows from generator to storage unit 110. The ability to store energy generated from a generator is well known in the art and can be incorporated herein. Furthermore, it is known in the art how to transfer rotational energy into electricity, such as the generator 108 generating electricity from rotation of the shaft 116.

The various elements of system 100 have been shown in block diagram without regards to size and specific structural details. As will be appreciated in light of the disclosure herein, such details and relative sizes can be modified to accommodate for a particular vehicle, engine, turbocharger, generator, blade, shaft, or combination thereof. Accordingly, specific structural details and relative sizes have been omitted from the figure for clarity.

Hybrid cars can be equipped to capture energy generated due to vehicle braking. Energy generated in this manner can create a mileage efficiency curve inverse to normal, in that city driving yields higher miles-per-gallon numbers than does highway driving. It is believed by the inventor that use of the invention in connection with the hybrid system of a hybrid vehicle will generate more energy the faster the engine goes, thus generating energy at highway speeds. By having this steady source of power, rather than having only the stop-and-go part of the cycle contributing, such as with the braking system, the battery reservoir would be able to be topped off by waste thermal energy from the engine exhaust, rather than or in addition to the recaptured kinetic energy coming from the brakes.

An advantageous element of hybrid systems is that they can enable the creation and consumption of energy to be asynchronous. The invention may provide another important input into that system, tapping a much more significant and steady conversion of waste energy than that provided by braking alone.

It is contemplated that system 100 can be incorporated into virtually any automobile which can utilize a turbocharger. For example, in one embodiment, the engine is a typical car or truck, such as a Toyota Camry or a Ford F-150 pickup truck. Furthermore, it is contemplated that the invention can be utilized in vehicles not equipped with hybrid systems. Also, it is contemplated that the invention can be utilized in connection with diesel, gas or other types of fueled engines which emit an exhaust stream. In the illustrated embodiment, the system 100 is utilized in connection with an automobile 200. However, it is contemplated that the invention can be incorporated into other types of systems utilizing an engine which produces a waste exhaust stream.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
an engine configured to produce an exhaust stream;
a housing in fluid communication with said exhaust stream;
a turbine blade associated with said housing, wherein said turbine blade is configured to be driven at least in part by said exhaust stream;
a generator linked to said turbine blade, wherein said generator is configured to generate electricity in response to the driving of said turbine blade.

2. A system as recited in claim 1, further comprising a shaft linking said generator to said turbine blade.

3. A system as recited in claim 1, further comprising a storage unit configured to store energy generated by said generator.

4. An automobile comprising the system as recited in claim 1.

5. A system for generating electricity in automobiles, comprising,
a blade configured to be in a path of a fluid stream, said blade configured to rotate as the fluid stream moves past said blade; and
a generator linked to said blade by a shaft, said generator being configured to generate electricity in response to rotation of said blade.

6. A system as recited in claim 5, further comprising a housing configured to force the fluid stream past said blade.

7. A system as recited in claim 5, further comprising a storage unit for storing the generated electricity.

8. A system as recited in claim 5, wherein said fluid stream is an exhaust stream from a combustion engine.
